(19) United States
(12) Patent Application Publication
(10) Pub. No.: US 2018/0071173 A1
(43) Pub. Date: Mar. 15, 2018

(54) Sleeve incorporating a cover means

(71) Applicant: RPF Developments Ltd, Essex (GB)

(72) Inventor: Kylie Hunter, Essex (GB)

(73) Assignee: RPF Developments Ltd, Essex (GB)

(21) Appl. No.: 15/702,268

(22) Filed: Sep. 12, 2017

(30) Foreign Application Priority Data
Sep. 13, 2016 (GB) GB1615545.9

(51) Int. Cl. A61J 17/02; A41B 13/00; A41B 13/08; A41D 27/10; A41D 19/01

(52) U.S. Cl. CPC A61J 17/02; A41B 13/005; A41D 19/01; A41D 27/10; A41B 13/08

(57) ABSTRACT

A sleeve (10) comprising an aperture (15) through which a hand (20) projects when worn, and a cover means (40) located adjacent the aperture, the cover means movable between a first position in which it allows access to the aperture from outside the sleeve, and a second position in which it covers a hand projecting through the aperture when the sleeve is worn.

### PRIORITY

The present application is related to, and claims the priority benefit of, Great Britain Patent Application Serial No. GB1615545.9, filed Sep. 13, 2016, the contents of which are incorporated herein directly and by reference in their entirety.

### FIELD OF THE INVENTION

The present invention relates generally to a sleeve incorporating a cover means, and finds particular, although not exclusive, utility in providing a means to cover an infant's hand.

### BACKGROUND

When it is cold it is known to use mittens or gloves to cover an infant's hand. However, such mittens and gloves are easily lost.

It would therefore be advantageous to have a means for keeping an infant's hand warm and which is difficult to become loose.

### BRIEF SUMMARY

In a first aspect, there is provided a sleeve comprising an aperture through which a hand projects when worn, and a cover means located adjacent the aperture, the cover means movable between a first position in which it allows access to the aperture from outside the sleeve, and a second position in which it covers a hand projecting through the aperture when the sleeve is worn.

In other words, it may cover the aperture.

The cover means may be a pocket attached to, or integral with the sleeve, the pocket being reversible to move between the first and second positions.

The pocket may be arranged on the outside, and at the end, of the sleeve adjacent the aperture.

The cover means may include a teething surface arranged such that with the cover means in the second position the teething surface is outermost relative to the sleeve. In this way, not only might an infant's hand be kept warm by the cover but also the cover may provide a teething surface on which the infant may teeth. The cover also prevents the infant from teething on their own hands or fingers which may be undesirable due to them becoming sore.

When in the second position the cover may extend over a wearer's hand so that it is readily available for being placed in the wearer's mouth for the purpose of teething.

The cover means may be arranged such that in the first position the teething surface is innermost relative to the sleeve. In this way, the teething surface may be hidden from view and kept clean. When the adult wants the infant to stop teething on the teething surface, for instance at meal times, the teething surface can be wiped clean with a sterilising material and then the cover means may be moved to the first position to hide it from view. The teething surface is then ready for the next use.

The article may be considered to be a teething mitten.

The sleeve may be incorporated into an item of infant's clothing. The item of clothing may have two such sleeves.

The teething surface may be a sheet of material. The pocket may be formed from this sheet, or only a portion of the pocket may comprise the sheet. The sheet may be attached to another layer of material forming the pocket.

The teething surface may be a sheet of material. In this regard the sheet may be laminar. It may be homogenous. It may be solid. It may be unbroken. It may be continuous with no holes. It may be non-woven. It may include at least one hole. It may be uniform.

The teething surface may be elastomeric. It may be at least partially elastomeric.

The teething surface may comprise any one or more of natural rubber, synthetic rubber, silicone, silicone rubber, and plastics.

The sleeve may be incorporated into a onesie, or a shirt, or an infant bodysuit, sweatshirt, or jacket. In this regard a onesie may be defined as an article of clothing which includes continuous connected portions which extend around the wearer's torso, arms and legs.

The item of teething surface may have a thickness in the range 1 to 5 mm. However, other ranges of thickness are contemplated such as 1 to 8 mm.

The teething surface may not be uniform in thickness having relatively thin and thick portions.

The above and other characteristics, features and advantages of the present invention will become apparent from the following detailed description, taken in conjunction with the accompanying drawings, which illustrate, by way of example, the principles of the invention.

### BRIEF DESCRIPTION OF THE DRAWINGS

This description is given for the sake of example only, without limiting the scope of the invention. The reference figures quoted below refer to the attached drawings. The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 is a view of a portion of a sleeve with the cover means in the first position, according to an exemplary embodiment of the present disclosure;

FIG. 2 is a view of the portion of sleeve of FIG. 1 with the cover means in the second position, according to an exemplary embodiment of the present disclosure;

FIG. 3 is a side view of a portion of a sleeve having an alternative cover means with the cover means in the second position, according to an exemplary embodiment of the present disclosure;

FIG. 4 is a view of a portion of a sleeve having another cover means with the cover means in the first position, according to an exemplary embodiment of the present disclosure; and

FIG. 5 is a view of the portion of sleeve of FIG. 4 with the cover means in the second position, according to an exemplary embodiment of the present disclosure.

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any embodiment or aspect of the invention may be combined in any suitable manner, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances.

The principles of the invention will now be described by a detailed description of at least one drawing relating to exemplary features of the invention. It is clear that other arrangements can be configured according to the knowledge of persons skilled in the art without departing from the underlying concept or technical teaching of the invention, the invention being limited only by the terms of the appended claims.

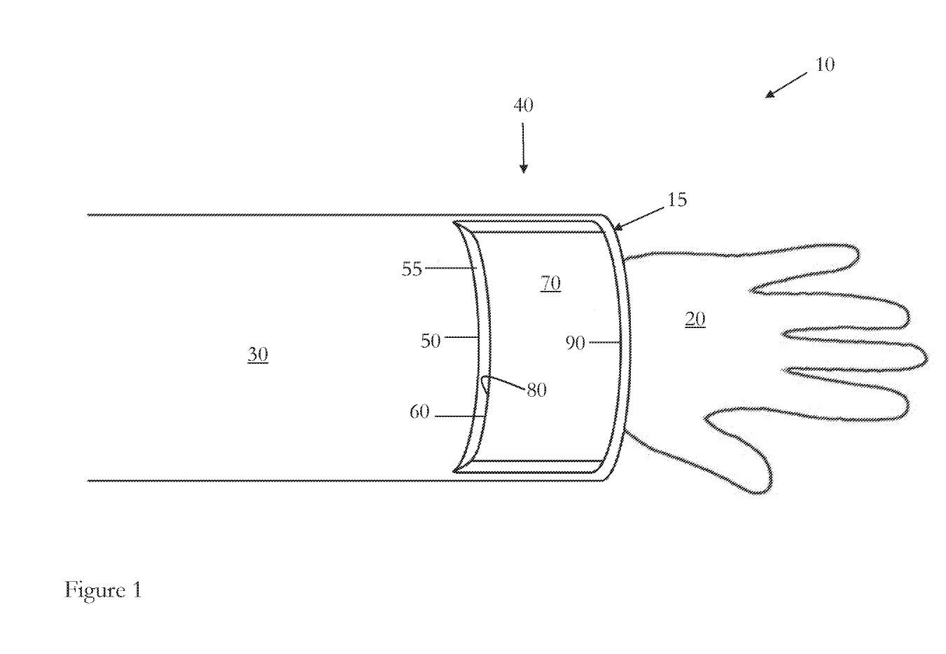

In FIG. 1, a sleeve 10 of an item of clothing is shown, the sleeve having the usual tubular construction 30. At one end an aperture 15 is arranged in the usual manner, such that when worn the wearer's hand 20 projects therethrough.

On the side of the end of the sleeve adjacent the aperture 15 a cover means 40 is arranged. This comprises two layers 50, 60 of material. Each layer is approximately rectangular and of similar size. A first layer of material 50 is attached to the sleeve by stitching or the like. A second layer of material 60 lies outwardly of, and over, the first layer 50. The second layer 60 is attached to the sleeve around three sides leaving the fourth side, which is the side furthest from the aperture 15, unattached. In this way the cover 40 is like a pocket with its opening on the side distal from the aperture 15 end of the sleeve.

The first layer 50 has an outer surface 55 which is covered by the second layer 60 in the position shown in FIG. 1. The second layer 60 has an outer surface 70 which is exposed in the position shown in FIG. 1, and an inner surface 80 which lies adjacent the outer surface 55 of the first layer.

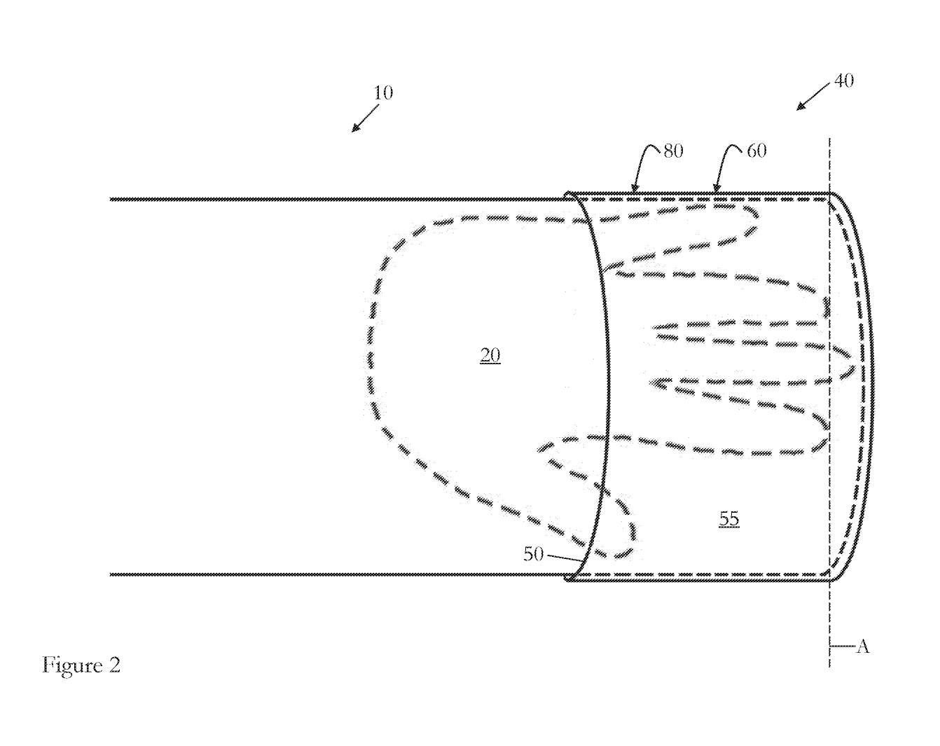

In FIG. 2, the cover means has been turned inside out such that the second layer 60 has been moved through 180 degrees about the axis referenced “A”. In this manner, the second layer 60 is now on the reverse side of the sleeve 10 from the first layer 50. Consequently, the outer surface 55 of the first layer 50 is now exposed.

Furthermore, what was the inner surface 80 of the second layer 60 is now exposed and what was the outer surface 70 of the second layer 60 is now hidden underneath the new outer surface 80 and immediately facing the outer surface of the sleeve.

In this manner the wearer's hand 20 (shown in broken lines) is encapsulated inside the cover means 40. The aperture 15 is now covered by the first and second layers 50, 60 being attached to one another along the side referenced “90” in FIG. 1.

In this regard the sleeve 10 may be slightly stretchable and/or chosen to be slightly longer than necessary so that the hand 20 may lie inside the sleeve 10.

In an alternative version, the first layer 50 is part of the sleeve 10 and the teething material may be integral therewith.

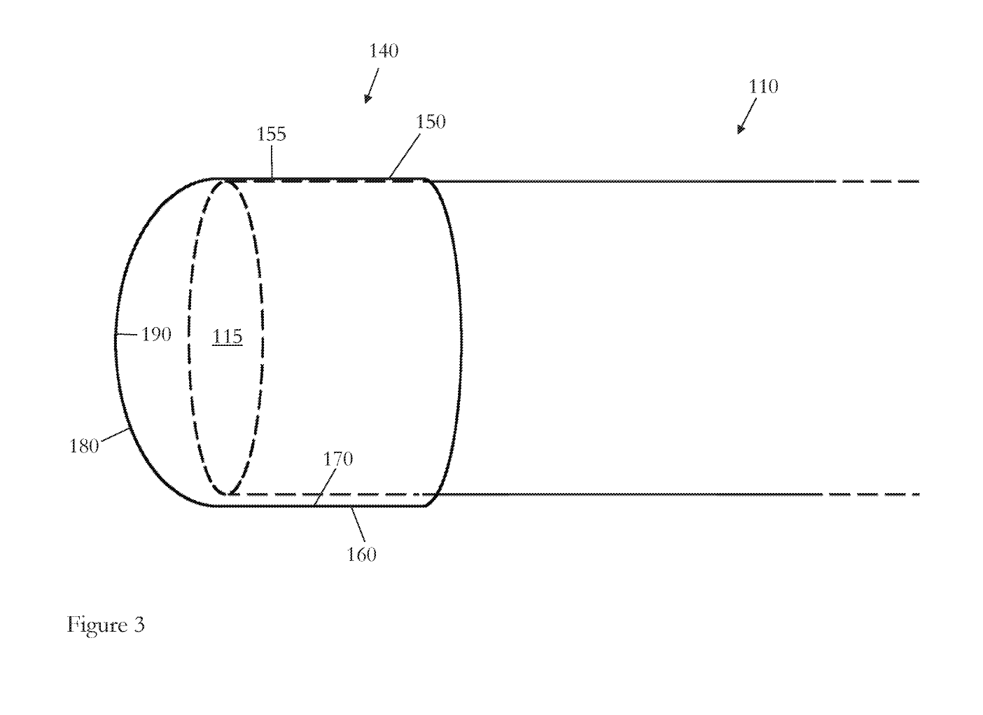

In FIG. 3 a view of another sleeve 110 is shown with an alternative cover means 140 in the closed positon. This cover means 140 is similar to the cover means 40 shown in FIGS. 1 and 2 in that it is formed of two layers 150, 160 of material, the outer layer 160 being foldable over the end of the sleeve 110 to cover the aperture 115. The layers 150, 160 are approximately rectangular in shape.

In this way, the outer surface 155 of the first layer 150 is exposed on one side of the sleeve and the previously inner surface 180 of the second layer 160 is now outermost. Similarly the previously outer surface 170 of the second layer 160 is now innermost and lies against the sleeve 110. The cover means 140 has a dome shape portion in front of the aperture 115 of the sleeve 110.

Teething material may form the first and/or second layers 50, 60, 150, 160 and/or be attached thereto. The teething material may be present on only one side of the layer(s), or both.

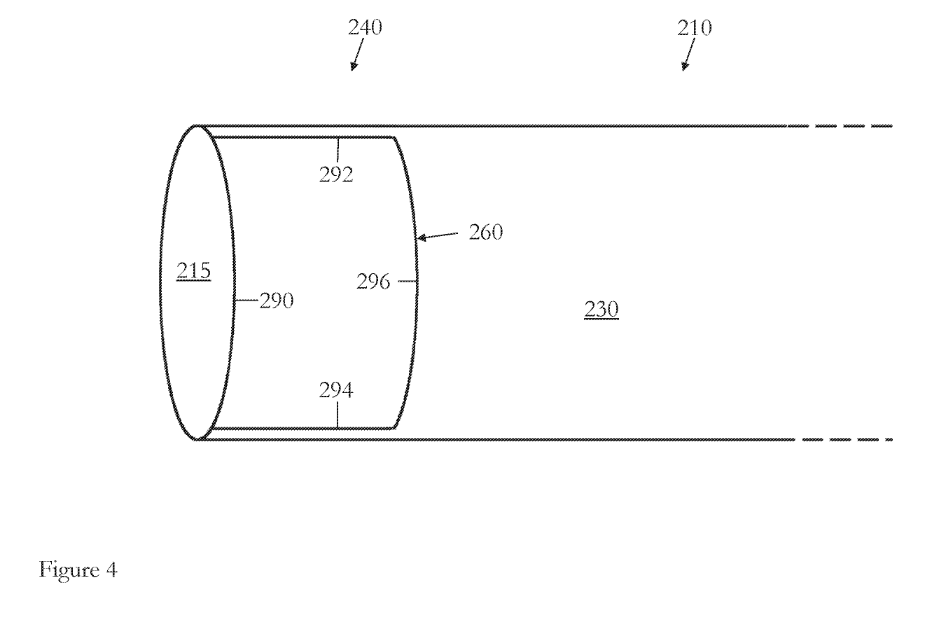

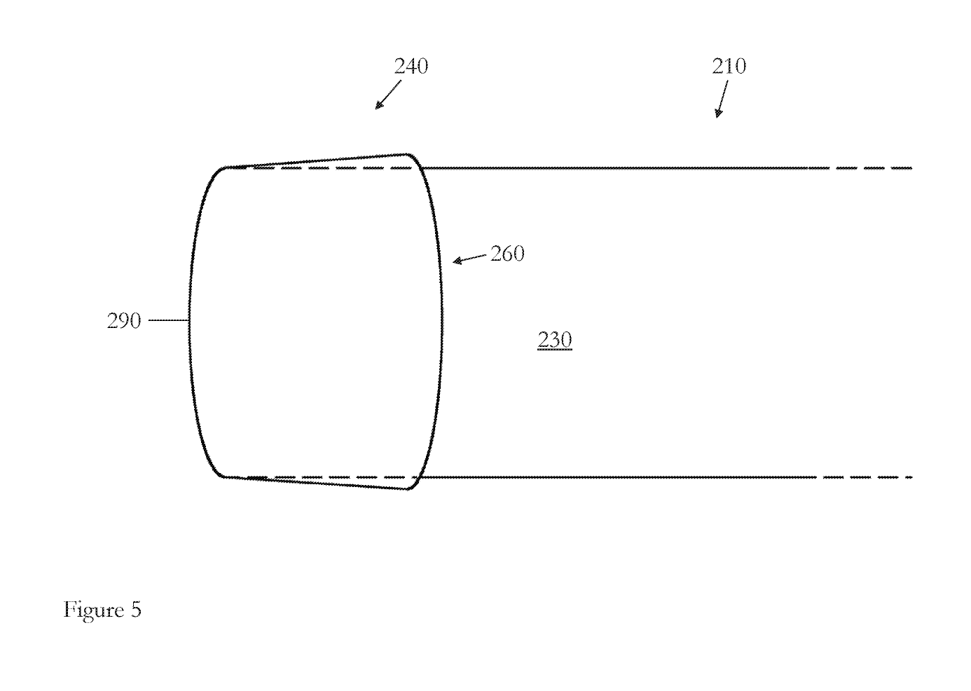

Another possibility is that there is only one layer in addition to the material 230 of the sleeve 210 as shown by the cover means 240 in FIGS. 4 and 5. This layer 260 is attached to the sleeve 210 around three sides 290, 292, 294 leaving the fourth side 2696 unattached to the sleeve. In this regard the layer 260 is approximately rectangular in shape.

To close the aperture 215 the layer 260 is folded over, about the seam 290, in a similar manner to that described with reference to FIGS. 1 to 3, such that it covers the aperture 215. This is shown in FIG. 5, where the seam 290 is shown at the end of the sleeve 210 opposite the aperture 215. The layer 260 now lies on the opposite side of the sleeve from where it was in FIG. 4.

The layer 260 may be formed completely or partially integrally with the sleeve such that no stitching is required to attach it to the sleeve or only partial stitching (for instance only along one or both sides 292, 294).

The layer 260 may comprise teething material or be attached thereto. Similarly, teething material may be integral with or attached to the outer surface of the sleeve material 230 in the area underneath the layer 260 when in the first position as shown in FIG. 4.

The teething material may be present on only one side of the layer, or both.

Shapes other than approximately rectangular are contemplated for any of the layers described herein, such as semi-circular and triangular.

The sleeves 10, 110, 210 may include releasable attachment means (not shown) for securing the layer 60, 160, 260 in either or both of the positions as shown in the figures. For instance, any of poppers, hook and loop material, and buttons may be used.

In one embodiment, the cover means may be retro-fittable to an existing item of clothing. In this case, the teething portion may include attachment means for attaching it to the sleeve of an existing item of clothing. The attachment means may be any of a strap, zip, poppers, hook and loop material, buttons, etc. Alternatively, it may be sewn to the sleeve.

While various embodiments of sleeves incorporating a cover means and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A sleeve comprising an aperture through which a hand projects when worn, and a cover means located adjacent the aperture, the cover means movable between a first position in which it allows access to the aperture from outside the sleeve, and a second position in which it covers a hand projecting through the aperture when the sleeve is worn.

2. The sleeve of claim 1, wherein the cover means is a pocket attached to, or integral with the sleeve, the pocket being reversible to move between the first and second positions.

3. The sleeve of claim 2, wherein the pocket is arranged on the outside, and at the end, of the sleeve adjacent the aperture.

4. The sleeve of claim 1, wherein the cover means includes a teething surface arranged such that with the cover means in the second position the teething surface is outermost relative to the sleeve.

5. The sleeve of claim 1, being incorporated into an item of infant's clothing.

6. The sleeve of claim 1, wherein the teething surface is a sheet of material.

7. The sleeve of claim 1, wherein the teething surface is elastomeric.

8. The sleeve of claim 1, wherein the teething surface comprises any one or more of natural rubber, synthetic rubber, silicone, silicone rubber, and plastics.

9. The sleeve of claim 1, being incorporated into a onesie.

10. The sleeve of claim 1, being incorporated into a shirt.

11. The sleeve of claim 1, being incorporated into an infant bodysuit.

12. The sleeve of claim 1, being incorporated into an infant sweatshirt.

13. The sleeve of claim 1, being incorporated into an infant jacket.

14. The sleeve of claim 1, wherein the teething surface has a thickness in the range 1 to 5 mm.

15. A sleeve comprising an aperture through which a hand projects when worn, and a cover means located adjacent the aperture, the cover means movable between a first position in which it allows access to the aperture from outside the sleeve, and a second position in which it covers a hand projecting through the aperture when the sleeve is worn, wherein the cover means is a pocket attached to, or integral with the sleeve, the pocket being reversible to move between the first and second positions, and wherein the cover means includes a teething surface arranged such that with the cover means in the second position the teething surface is outermost relative to the sleeve.
